(19) United States
(12) Patent Application Publication
(10) Pub. No.: US 2016/0153454 A1
(43) Pub. Date: Jun. 2, 2016

(54) ANTI-FREEZE DISTRIBUTION SYSTEM

(71) Applicants: Eric Kuegeler, Riverton, WY (US); Shawn Murray, Lander, WY (US)

(72) Inventors: Eric Kuegeler, Riverton, WY (US); Shawn Murray, Lander, WY (US)

(21) Appl. No.: 14/557,354

(22) Filed: Dec. 1, 2014

(51) Int. Cl. F04D 13/04; F15B 21/00; F02C 1/02; F15B 15/20

(52) U.S. Cl. CPC F04D 13/04; F15B 15/20; F15B 21/00; F02C 1/02; F04D 13/046

(57) ABSTRACT

A method and system for providing radiant heat to prevent freezing, which may include an emission-free, compressed-gas motor for driving a pump for pressurizing a liquid in a closed fluid pathway. The motor may include an inlet port and an exhaust port. The inlet port may be connected to a pressurized natural gas line. The exhaust port of the motor may also be connected to the natural gas line so that natural gas is lost during operation of the motor. A burner may heat the liquid in the closed fluid pathway using natural gas from the natural gas line. The heated liquid in the closed fluid pathway may provide radiant heat at desired locations, including other pipes and storage tanks. The motor may also be used for dehydrating natural gas.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Present Disclosure

The present disclosure relates generally to systems and methods for preventing liquids from freezing in storage tanks and pipelines.

2. Description of Related Art

Natural gas wellheads are typically located in remote locations that may not have connections to public utilities, such as power grids. During the winter, temperatures at wellhead locations may drop below freezing. This may cause problems for liquids in storage tanks and pipelines stored near the wellheads and natural gas lines. In some instances, these liquids may freeze. Further, since electricity is not generally available at wellhead locations it may be difficult to provide a constant source of heat to keep storage tanks and pipelines from freezing. One source of heat may be the natural gas extracted from the well head. For example, a burner using natural gas as a fuel may be utilized to provide heat.

To overcome the lack of electrical power at most wellheads, well operators have in the past employed compressed-gas motors, sometimes referred to as “air-motors.” In particular, these motors were commonly powered by the pressurized gas extracted from the wellhead. However, one significant drawback to the use of the previously available motors powered by pressurized gas extracted from a wellhead was that the motors exhausted natural gas directly into the atmosphere. This may be problematic for two reasons, namely, economic and environmental. First, gasses released into the atmosphere by previously available motors cannot be sold to consumers thereby resulting in an economic loss to well operators. Second, gasses released into the atmosphere by previously available motors may include greenhouse gasses, which may contribute to the greenhouse effect. Increased regulation from governmental agencies is limiting greenhouse gas emissions.

Recent attempts to reduce emissions associated with previously available motors have included the adoption of solar or wind powered electrical motors for driving pumps. However, a significant drawback to both solar and wind powered solutions is the need for costly battery arrays to power the motor. It would therefore be an improvement over the previously available devices to provide a compressed-gas motor that does not result in the emission of greenhouse gases into the atmosphere. It would be a further improvement over the previously available devices to eliminate the need for costly battery arrays and other costly components for generating electricity from wind or solar power.

In addition, it may be beneficial to provide an emission free, compressed-gas motor for use in natural gas dehydration. In particular, natural gas utilized by consumers is composed almost entirely of methane. Raw natural gas found at a wellhead, however, exists in mixtures with other hydrocarbons, such as ethane, propane, butane, and pentanes. In addition, raw natural gas may contain other impurities, such as water vapor. A gas stream that includes water vapor mixed in may be referred to herein as a “wet gas stream.” A gas stream that has had some or all of its water vapor removed therefrom may be referred to herein as a “dry gas stream.”

The removal of water vapor from a wet gas stream may require a complex treatment. For example, a water-removal treatment may include dehydrating the natural gas through a process known as “absorption.” Absorption occurs when the water vapor in the wet gas stream is removed by a dehydrating agent that has a chemical affinity for water. The dehydrating agent may be mixed into the wet gas stream in a chamber of a dehydrator. When the dehydrating agent comes into contact with the water molecules in the wet gas stream, the dehydrating agent will bond with the water. Once the water has been absorbed, the dehydrating agent, now heavier, may sink to the bottom of the dehydrator. The natural gas, having been stripped of most of its water content, is then transported out of the dehydrator. The dehydrating agent, along with the water bonded thereto, may be directed into a separator, which typically includes a specialized boiler that is designed to vaporize only the water out of the solution. This is possible because the boiling point of the water may be much lower than the boiling point of the dehydrating agent.

Once the water has been separated, the dehydrating agent may be re-injected into the wet gas stream for re-use. Glycol-based solutions, such as triethylene glycol, are known suitable dehydrating agents. In addition to removing water from a wet gas stream, the dehydrating agent may also be utilized as an anti-freezing agent to prevent freezing in nearby water and gas lines, or any other type of line. In a natural gas dehydration system, it may be beneficial to circulate a dehydration agent through the dehydrator, separator and other lines by a pump connected to a motor. It would therefore be useful to provide an emission free, compressed-gas motor for use in natural gas dehydration.

The prior art is thus characterized by several disadvantages that are addressed by the present disclosure. The present disclosure minimizes, and in some aspects eliminates, the above-mentioned failures, and other problems, by utilizing the methods and structural features described herein. For example, the present disclosure may eliminate the release of gasses to the atmosphere in conjunction with the operation of a motor used to drive a pump for circulating a dehydration agent. This may result in both an economic benefit to the well operator as well a benefit to the environment.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a diagram of a system for dehydrating natural gas pursuant to an embodiment of the present disclosure;

FIG. 2 is a diagram of the inner workings of a centrifugal pump pursuant to an embodiment of the present disclosure;

FIG. 3 is a diagram of the inner workings of a rotary vane motor pursuant to an embodiment of the present disclosure;

FIG. 4 is a diagram of a system for dehydrating natural gas pursuant to an embodiment of the present disclosure; and

FIG. 5 is a diagram of an anti-freeze system pursuant to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method steps.

Applicants have discovered a method and system for providing thermal energy at remote locations. The thermal energy may be utilized to prevent freezing, such as preventing freezing of liquids in tanks and pipelines. In an embodiment of the present disclosure, the system and method may include circulating a heated liquid in a closed, fluid pathway. The liquid may be heated by a gas burner, such as a natural-gas burner. An emission-free, compressed gas motor may drive a pump that circulates the heated liquid in the closed, fluid pathway. The heated liquid may provide radiant heat for preventing freezing. For example, the fluid pathway may run in close proximity to pipes prone to freezing.

Applicants have further discovered an emission free, compressed-gas motor for use in proximity near a main gas line, such as a natural-gas main line. The applicants' emission-free motor may produce rotational power at an output shaft when pressurized gas from the main gas line is supplied at an inlet port. In particular, the pressurized gas may perform work inside of a housing of the motor to rotate the output shaft. Exhaust gas from the emission-free motor may be directed from an exhaust port and back into the main gas line such that no harmful gasses are emitted into the atmosphere during the operation of the motor. In an embodiment of the present disclosure, the applicants' emission-free motor may be utilized to drive a pump for circulating a liquid agent in a fluid pathway. In an embodiment of the present disclosure, the liquid agent may function as a dehydrating agent, an anti-freezing agent, or both.

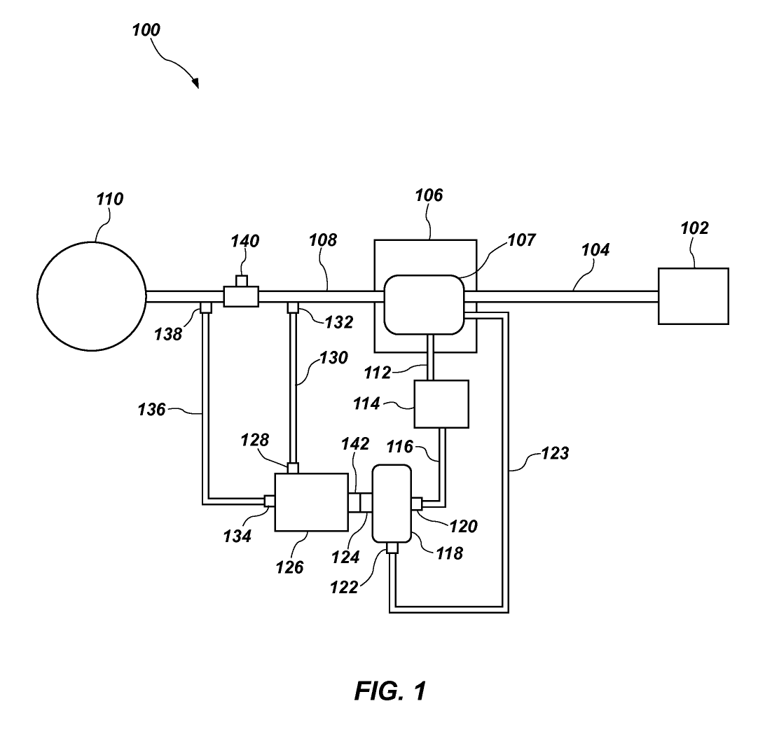

Referring now to FIG. 1, there is depicted a natural gas dehydration system 100 pursuant to an embodiment of the present disclosure. A wellhead 102 may supply a wet gas stream, e.g., a mixture of natural gas and water vapor, through a main line 104 to a dehydrator 106. The wet gas stream may be pressurized by natural pressure from underneath the ground or by a pump (not shown). The wet gas stream may contain other gases and impurities besides the water vapor and the natural gases. These other gases may be removed from the wet gas stream prior to the dehydrator 106 as is known to one having ordinary skill in the art. Alternatively, the other gases and impurities may not be removed from the wet gas stream.

The dehydrator 106 may remove the water vapor from the wet gas stream using a dehydrating agent, such as glycol. In particular, the dehydrating agent may be introduced into the wet gas stream inside of a chamber 107 of the dehydrator 106 at a pressure greater than that of the wet gas stream. The dehydrating agent may have a high affinity for water thereby causing the dehydrating agent to bond with the water in the wet gas stream inside of the chamber 107. A dry gas stream, i.e., a gas stream from which water has been partially or entirely removed, may exit the chamber 107 of the dehydrator 106 via a line 108 that leads to a storage tank 110 or any other destination. For example, the dried natural gas may be stored in the storage tank 110 or diverted directly for consumer use.

The dehydrating agent bonded to the water may exit the chamber 107 of the dehydrator 106 via a line 112 that leads to a separator 114. In an embodiment of the present disclosure, the separator 114 may include a boiler (not shown) for heating the dehydrating agent bonded to the water. Because of the lower boiling point of the water as compared to the dehydrating agent, the water and the dehydrating agent may be separated by the separator 114 as is known to one having ordinary skill in the art.

The dehydrating agent may exit the separator 114 via a line 116 and the water may be discarded onto the ground or into a tank. The line 116 may lead to an inlet 120 of a pump 118. The pump 118 may be operable to re-circulate the rejuvenated dehydrating agent back into the dehydrator 106 via a line 123, which is connected to an outlet 122 of the pump 118. Thus, it will be appreciated that the dehydrating agent may be re-used indefinitely to dehydrate the wet gas stream from the wellhead 102 or any other source. It will be further appreciated, that the dehydration agent may be heated by the separator 114.

The pump 118 may include a drive shaft 124 that is coupled to an outlet shaft 142 of a motor 126. The motor 126 may be powered by pressurized gas from the line 108. In particular, the motor 126 may comprise an inlet 128 that is connected to a line 130. The line 130 may be connected to the line 108 at a coupling 132. The motor 126 may further comprise an outlet 134 that is connected to a line 136. The line 136 may also be connected to the line 108 at a coupling 138. The couplings 132 and 138 may be spaced apart from each other on the line 108. It will be appreciated that the couplings 132 and 138 may be utilized to connect the lines 130 and 136, respectively, to the line 108 to thereby form gas passageways between the line 108 and the inlet 128 and the outlet 134 of the motor 126, respectively. As used herein, the term “line” may refer to a pipe, tube or conduit, used to transport and direct liquids or gases between two points.

An in-line pressure reducer 140 may be interposed in the line 108 between the couplings 132 and 138. The pressure reducer 140 may create a pressure differential in the line 108. In an embodiment of the present disclosure, the pressure differential formed by the pressure reducer 140 may be about between 15 to 90 pounds per square inch (psi). In an embodiment of the present disclosure, the pressure differential formed by the pressure reducer 140 may be about between 30 to 75 pounds per square inch. In an embodiment of the present disclosure, the pressure differential formed by the pressure reducer 140 may be about between 30 to 40 pounds per square inch. In an embodiment of the present disclosure, the pressure differential formed by the pressure reducer 140 may be about between 60 to 80 pounds per square inch. In an embodiment of the present disclosure, the pressure reducer 140 may comprise a differential valve.

In an embodiment of the present disclosure, the pressure of the gas in the line 108 at the coupling 132 may be greater than the pressure of the gas in the line 108 at the coupling 138. As will be explained in further detail below, the pressure differential generated by the pressure reducer 140, or a differential valve, allows the gas exhausted from the motor 126 to be re-introduced back into the line 108. In an embodiment of the present disclosure, the pressure reducer 140 may be an active component to thereby maintain a preset and constant pressure differential, or range, to thereby ensure consistent operation of the motor 126. This may be necessary to due to natural fluctuations of the pressure of the gas stream inside of the line 108. In an embodiment of the present disclosure, the pressure reducer 140 may comprise an in-line choke.

As mentioned, the motor 126 may be driven by the pressurized gas from the line 108. In this regard, the motor 126 may produce rotational power developed at the shaft 142 when pressurized gas is supplied at the inlet 128. The pressurized gas may perform work inside of the motor 126 to rotate the shaft 142. The gas, however, is not combusted to perform the work. That is, the motor 126 may not be a combustion-type motor.

Gas exhausted from the motor 126 at the outlet 134 is reintroduced back into the gas stream in the line 108 at coupling 138. This is possible because the pressure in the line 108 at the coupling 138 is lower than the pressure in the line 108 at the coupling 132 due to the employment of the pressure reducer 140. Further, the pressure in the line 108 at the coupling 138 may be lower than the pressure at the outlet 134 of the motor 126. The gas returned to the gas stream in the line 108 at the coupling 138 may then travel to storage tank 110, or other destination, along with the gas that passed directly through the pressure reducer 140. Thus, it will be appreciated that pursuant to an embodiment of the present disclosure, no gas is emitted into the atmosphere during the operation of the motor 126 due to the closed gas pathway between the motor 126 and the line 108. All, or substantially all, gases utilized to drive the motor 126 may be returned to the line 108.

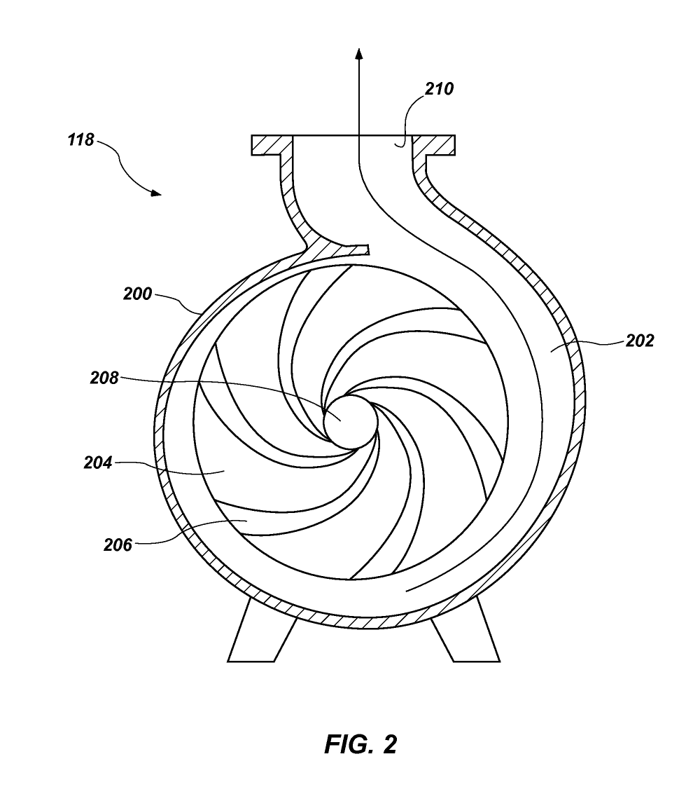

Referring now to FIG. 2, there is depicted a diagram of the inner workings of the pump 118 pursuant to an embodiment of the present disclosure. The pump 118 may be a centrifugal-type pump. The pump 118 may comprise a sealed casing or housing 200. A flow area 202 may be defined by the casing 200. Disposed in the flow area 202 may be an impeller 204 having a plurality of vanes 206. Centrally located in the impeller 204 may be a suction eye 208.

The impeller 204 may be connected to the drive shaft 124 (see FIG. 1). As the impeller 204 is rotated by the drive shaft 124, the dehydrating agent may be sucked into the flow area 202 at the suction eye 208. The suction eye 208 may be connected to the inlet 120 (see FIG. 1) of the pump 118. Further rotation of the impeller 204 may force the dehydrating agent from the eye 208 and outward along the vanes 206. Because the vanes 206 may be curved, the dehydrating agent may be pushed out of the flow area 202 and into a discharge port 210. The discharge port 210 may be connected to the outlet 122 (see FIG. 1) of the pump 118.

It will be appreciated that the pump 118 may not be limited to a centrifugal pump and that other types of fluid pumps may be utilized with the present disclosure, including both open face pumps and closed face pumps. In an embodiment of the present disclosure, the components of the pump 118 may be made of brass.

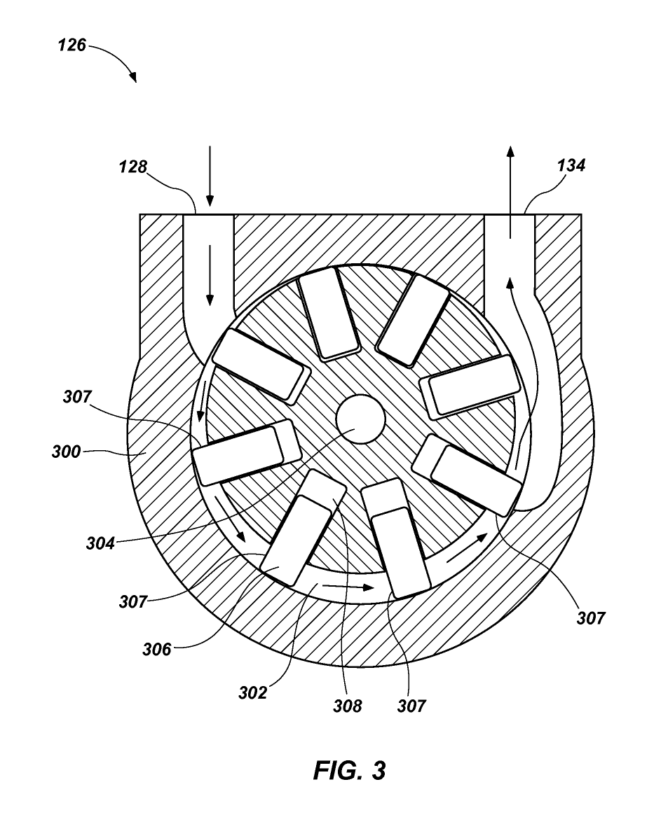

Referring now to FIG. 3, there is depicted a diagram of the inner workings of the motor 126 pursuant to an embodiment of the present disclosure. The motor 126 may be a compressed-gas motor. The motor 126 may not be a combustion-type motor. The motor 126 may comprise a housing 300 having the inlet port 128 and the outlet or exhaust port 134 (see FIG. 1). Extending between the inlet 128 and the outlet 134 may be a gas passageway 302 for allowing passage of compressed gas from the inlet 128 to the outlet 134. The arrows indicate the flow of the gas through the housing 300.

A shaft 304 may be rotatably or movably mounted to the housing 300. A plurality of vanes 306 may be mounted in slots 308 in the shaft 304. The slots 308 may extend radially outward from the center of the shaft 304. Compressed gas flowing through the gas passageway 302 may directly pressurize exposed surfaces 307 of the vanes 306, which may be biased outwards by compressed gas or a resilient member (not shown). The pressure on the exposed surfaces 307 of the vanes 306 from the compressed gas may cause the shaft 304 to rotate. The shaft 304 may be mounted off center in the gas passageway 302 such that the vanes 306 may extend from the slots 308 in a lower portion of the gas passageway 302. The vanes 306 may be pushed back into the slots 308 in an upper portion of the passageway 302 by the housing 300.

The compressed gas, reduced in pressure, exits the passageway 302 through the outlet 134. In an embodiment of the present disclosure, the shaft 304 may include eight (8) or more vanes 306. The use of eight (8) or more vanes 306 may facilitate operation of the motor 126 at low pressures. The pressure of the compressed gas at the inlet 128 may be higher than the pressure of the compressed gas at the outlet 134 due to the work performed by the gas inside of the housing 300 to turn the shaft 304.

Other types of compressed-gas motors may be utilized with the present disclosure. In an embodiment of the present disclosure, the motor 126 may comprise a turbine powered by compressed gas. In an embodiment of the present disclosure, the motor 126 may comprise one or more pistons powered by compressed gas. In an embodiment of the present disclosure, the motor 126 may comprise a rotary piston powered by compressed gas. In an embodiment of the present disclosure, the motor 126 may comprise a diaphragm. It will therefore be appreciated that almost any motor configuration powered by compressed-gas, and not combustion, may be suitable for use with the present disclosure.

Some considerations may apply to the motor 126 and its operation. For example, the motor 126 may need to be able to withstand high-pressure testing as required by governmental regulations for systems that transport natural gas. Further, the motor 126 may have to be suitable for operation at the low pressures found in natural gas lines. The motor 126 may need to run at nearly constant speeds despite fluctuations in gas pressure in the main line 108. The motor 126 may also need to run despite impurities in the natural gas stream. In an embodiment of the present disclosure, the motor 126 may operate using one of a wet natural gas stream and a dry natural gas stream.

It will be further appreciated that the motor 126 and the pump 118 may be of unitary or disparate construction. For example, in an embodiment of the present disclosure, the motor 126 and the pump 118 may both be integrated into the same housing structure. In an embodiment of the present disclosure, the motor 126 and the pump 118 may have separate housings. In an embodiment of the present disclosure, the motor 126 may provide mechanical energy for powering another device, such as a pump. A lubrication system (not shown) may provide lubrication to the motor 126 and the pump 118.

It will be appreciated that the structure and apparatus disclosed herein is merely one example of a means for providing an emission-free motor operated by pressurized gas, and it should be appreciated that any structure, apparatus or system for providing an emission-free motor which performs functions the same as, or equivalent to, those disclosed herein are intended to fall within the scope of a means for, including those structures, apparatus or systems for providing an emission-free motor which are presently known, or which may become available in the future. Anything which functions the same as, or equivalently to, a means for providing an emission-free motor falls within the scope of this element.

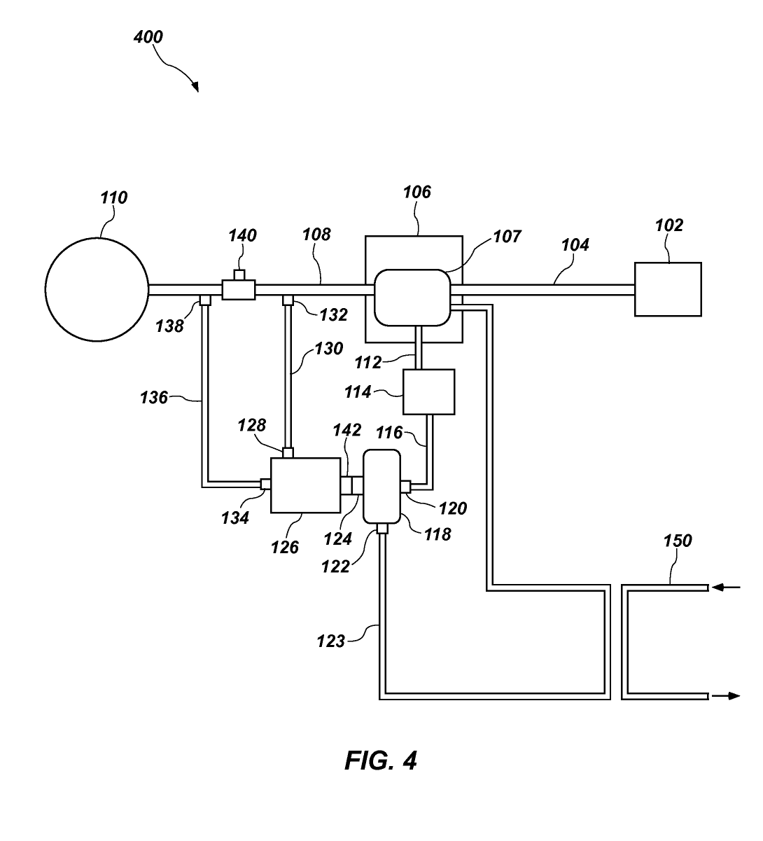

Referring now to FIG. 4, there is depicted a gas dehydration system 400 pursuant to an embodiment of the present disclosure, where like reference numerals indicate like components as described above. In FIG. 4, the primary difference from FIG. 1 is that the line 123 may be routed to a position that is proximate to line 150. The dehydrating agent in line 123 may function as an anti-freezing agent to prevent the liquid in line 150 from freezing in low temperatures by providing radiant heat. In particular, the dehydrating agent in the line 123 may be heated by the separator 114 and the dehydrating agent may serve to prevent freezing in the line 150. The liquid in the line 150 may comprise water, gas, or any other liquid.

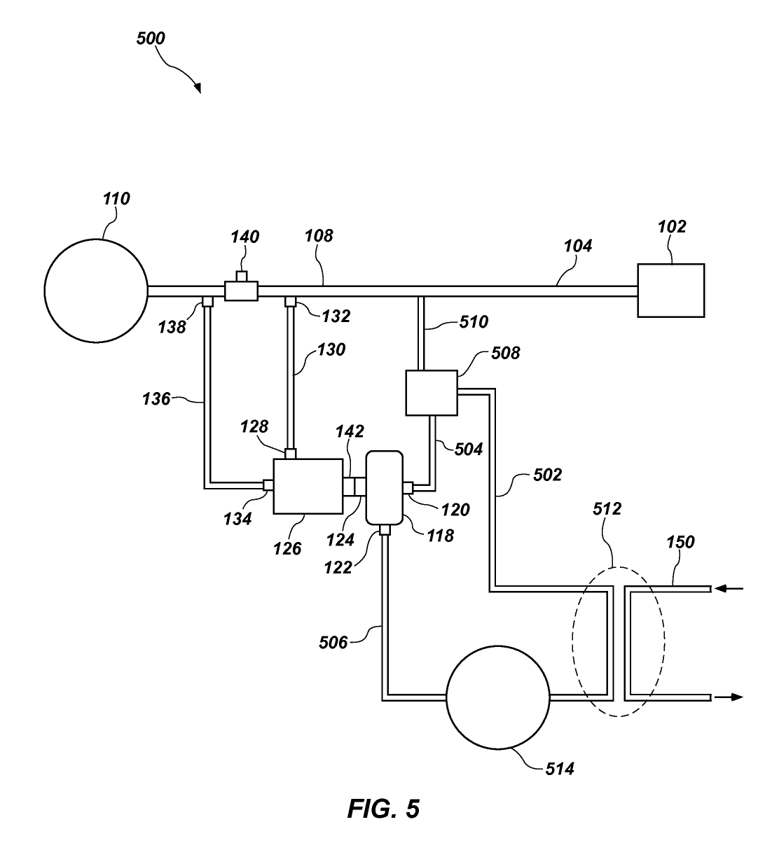

Referring now to FIG. 5, there is depicted a system 500 pursuant to an embodiment of the present disclosure, where like reference numerals indicate like components as described above. The pump 118 may be interconnected to a closed fluid pathway 502. The pump 118 may circulate a liquid, such as an anti-freezing agent, e.g., glycol, in the closed fluid pathway 502. The closed fluid pathway 502 may be formed from pipes or lines as is known to one having ordinary skill in the art. A portion 504 of the pathway 502 may be connected to the inlet 120 of the pump 118. A portion 506 of the pathway 502 may be connected to the outlet 122 of the pump 118. A portion of the pathway 502 may pass through the pump 118.

Liquid in the pathway 502 may be heated by a burner 508. The burner 508 may be a natural-gas burner. A supply line 510 for the burner 508 may be connected to the main gas line 104. Ambient temperature may dictate the heating of the liquid in the pathway 502. For example, in colder weather, it may be necessary to heat the liquid in the pathway 502 to a higher temperature.

The heated liquid in the pathway 502 may provide radiant heat for preventing freezing. The pathway 502 may function as a heat tracer, i.e., it may pass within close proximity of the line 150, as indicated by the area marked with the reference numeral 512. Heat may flow from the liquid in the pathway 502 to the line 150 to prevent freezing. Likewise, the pathway 502 may pass through, or in close proximity to, a storage tank 514 to prevent freezing inside of the tank 514. The closed nature of the pathway 502 allows the liquid in the pathway 502 to be re-heated by the burner 508.

In an embodiment of the present disclosure, the liquid in the pathway 502 may comprise glycol. As explained above, the motor 126 may be an emission-free, compressed-gas motor powered by natural gas in the main gas line. In this manner, the fluid pathway 502 may function as a heat tracer to maintain or raise the temperature of pipes, vessels, and/or storage tanks. The fluid pathway 502 may be covered in insulation to prevent heat loss and may be routed underground.

In accordance with the features and combinations described above, a useful method of providing an emission-free source of mechanical energy using a portion of a pressurized gas stream in a main gas line may include the steps of:

(a) directing a portion of the pressurized gas stream in the main gas line into an inlet of a compressed-gas motor, the compressed-gas motor having a shaft;

(b) rotating the shaft of the compressed-gas motor using the portion of the pressurized gas stream diverted from the main gas line; and

(c) directing the portion of the pressurized gas stream exhausted from an outlet of the compressed-gas motor back into the main gas line such that no gas is emitted into the atmosphere.

Those having ordinary skill in the relevant art will appreciate the advantages provided by the features of the present disclosure. For example, it is a feature of the present disclosure to provide an emission-free motor, powered by pressurized gas from a natural gas pipeline, that does not emit exhaust gases into the atmosphere during operation. Another feature of the present disclosure is to provide an emission-free system for circulating a dehydrating agent for use in conjunction with dehydrating a natural gas stream. It is another feature of the present disclosure to provide an emission-free system for circulating an anti-freezing agent in a pipeline. It is another feature of the present disclosure to provide an emission-free system for circulating a liquid in a pipeline.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An apparatus for producing mechanical energy from a pressurized gas stream transported in a main gas line:
a compressed-gas powered motor having a motor housing with a gas inlet port and a gas exhaust port;
a gas passageway in the motor housing, the gas passageway extending between the gas inlet port and the gas exhaust port;
a gas feed line connected to the main gas line and the gas inlet port of the motor housing; and
a gas return line connected to the main gas line and the gas exhaust port of the motor housing.

2. The apparatus of claim 1, wherein said compressed-gas powered motor further comprises a shaft movably mounted to the housing and a surface coupled to the shaft, and wherein a portion of the pressured gas stream diverted from the main gas line and into the gas passageway in the motor housing performs work on the surface to move the shaft.

3. The apparatus of claim 1, further comprising a pressure reducer disposed in said main gas line between a connection to the gas feed line and a connection to the gas return line.

4. The apparatus of claim 3, wherein the pressure reducer forms a pressure differential in the main gas line of about 15 to 90 pounds per square inch.

5. The apparatus of claim 4, wherein the pressure differential is about 30 to 40 pounds per square inch.

6. The apparatus of claim 4, wherein the pressure differential is about 60 to 80 pounds per square inch.

7. The apparatus of claim 1, wherein said gas stream comprises one of a wet natural gas stream and a dry natural gas stream.

8. The apparatus of claim 1, wherein the compressed-gas powered motor comprises rotary vanes.

9. The apparatus of claim 1, wherein the compressed-gas powered motor comprises a turbine.

10. The apparatus of claim 1, wherein the compressed-gas powered motor comprises a piston.

11. The apparatus of claim 1, wherein the compressed-gas powered motor comprises a diaphragm.

12. An apparatus for pumping a liquid using a pressurized gas stream diverted from a main gas line, said apparatus comprising:
a compressed-gas powered motor having a motor housing with a gas inlet port and a gas exhaust port;
the compressed-gas powered motor further having an output shaft;
a gas feed line connected to the main gas line and the gas inlet port of the motor housing;
a gas return line connected to the main gas line and the gas exhaust port of the motor housing; and
a pump having an input shaft, wherein the input shaft of the pump is coupled to the output shaft of the compressed-gas powered motor.

13. The apparatus of claim 12, wherein said compressed-gas powered motor further comprises a surface coupled to the output shaft, and wherein the pressured gas stream performs work on the surface to move the output shaft.

14. The apparatus of claim 12, further comprising a pressure reducer disposed in said main gas line between a connection to the gas feed line and a connection to the gas return line.

15. The apparatus of claim 14, wherein the pressure reducer forms a pressure differential in the main gas line of about 15 to 90 pounds per square inch.

16. The apparatus of claim 15, wherein the pressure differential is about 30 to 40 pounds per square inch.

17. The apparatus of claim 15, wherein the pressure differential is about 60 to 80 pounds per square inch.

18. The apparatus of claim 12, wherein the pump is a centrifugal pump.

19. The apparatus of claim 12, wherein said pressurized gas stream is one of a wet natural gas stream and a dry natural gas stream.

20. The apparatus of claim 12, wherein the compressed-gas powered motor comprises rotary vanes.

21. The apparatus of claim 12, wherein the compressed-gas powered motor comprises a turbine.

22. The apparatus of claim 12, wherein the compressed-gas powered motor comprises a piston.

23. The apparatus of claim 12, wherein the compressed-gas powered motor comprises a diaphragm.

24. The apparatus of claim 12, wherein the input shaft of the pump is coupled to the output shaft of the motor using a lovejoy coupling.

25. A system for pumping a liquid, said system comprising:
a main gas line for directing a pressurized gas stream from a gas source to a destination;
a line for transporting the liquid;
a pump for pressurizing the liquid in the line;
a compressed-gas powered motor for powering the pump, said compressed-gas powered motor having a motor housing with a gas inlet port and a gas exhaust port;
a gas feed line connected to the main gas line and the gas inlet port of the motor housing; and
a gas return line connected to the main gas line and the gas exhaust port of the motor housing;
wherein a pressure differential between the gas feed line and the gas return line is about 15 to 90 pounds per square inch.

26. The system of claim 25, wherein said compressed-gas powered motor further comprises a surface coupled to an output shaft, and wherein a portion of the pressurized gas stream diverted from the main gas line performs work on the surface to rotate the output shaft.

27. The system of claim 25, further comprising a pressure reducer disposed in said main gas line a connection to the gas feed line and a connection to the gas return line.

28. The system of claim 25, wherein the compressed-gas powered motor comprises rotary vanes.

29. The system of claim 25, wherein the compressed-gas powered motor comprises a turbine.

30. The system of claim 25, wherein the compressed-gas powered motor comprises a piston.

31. The system of claim 25, wherein the compressed-gas powered motor comprises a diaphragm.

32. The system of claim 25, further comprising a heater for heating the liquid.

33. The system of claim 25, wherein the pressurized gas stream comprises a combustible gas.

34. The system of claim 25, wherein the pressurized gas stream comprises natural gas.

35. The system of claim 25, wherein the liquid comprises a dehydrating agent.

36. A method for producing mechanical energy from a pressurized gas stream in a main gas line, the method comprising:
diverting a portion of the pressurized gas stream in the main gas line into an inlet of a compressed-gas powered motor, said compressed-gas powered motor having a shaft movably mounted to a motor housing;
moving the shaft of the compressed-gas powered motor using work performed by the portion of the pressurized gas stream diverted from the main gas line; and
directing the portion of the pressurized gas stream exhausted from an exhaust outlet of the compressed-gas powered motor back into the main gas line.

37. The method of claim 36, further comprising forming a pressure differential in the main gas line between a point where the portion of the pressurized gas stream is diverted from the main gas line and a point where the portion of the pressurized gas stream is returned to the main gas line.

38. The method of claim 37, wherein the pressure differential is about 15 to 90 pounds per square inch.

39. The method of claim 37, wherein the pressure differential is about 30 to 40 pounds per square inch.

40. The method of claim 37, wherein the pressure differential is about 60 to 80 pounds per square inch.

41. The method of claim 36, further comprising driving a pump with the shaft of the compressed-gas powered motor.

42. The method of claim 41, further comprising circulating a dehydrating agent between a dehydrator and a separator using the pump.

43. The method of claim 41, further comprising circulating an anti-freezing agent using the pump.

44. The method of claim 36, wherein the compressed-gas powered motor comprises rotary vanes.

45. The method of claim 36, wherein the compressed-gas powered motor comprises a turbine.

46. The method of claim 36, wherein the compressed-gas powered motor comprises a piston.

47. The method of claim 36, wherein the compressed-gas powered motor comprises a diaphragm.

48. The method of claim 36, wherein the pressurized gas stream comprises a combustible gas.

49. The method of claim 48, wherein the pressurized gas stream comprises natural gas.

50. A system for pumping a liquid, said system comprising:
a main gas line for directing a natural gas stream from a natural gas source to a destination;
a line for transporting the liquid;
a circulation system, wherein a portion of the circulation system is positioned to pass within adequate proximity to the line to thereby pass radiant heat to a substance inside of the line in order to prevent the substance from freezing;
a centrifugal pump installed into the circulation system, the centrifugal pump operable to circulate the a heat-producing agent in the circulation system;
a compressed-gas powered motor for driving the pump, said compressed-gas powered motor having a motor housing with a gas inlet port and a gas exhaust port;
the compressed-gas powered motor further comprising a gas passageway extending from the gas inlet port to the gas exhaust port inside of the motor housing;
a shaft rotatably mounted to the motor housing;
a plurality of vanes extending from the shaft inside of the gas passageway;
a gas feed line connected to the main gas line and the gas inlet port of the motor housing;
a gas return line connected to the main gas line and the gas exhaust port of the motor housing; and
a pressure reducer disposed in said main gas line between a connection to the gas feed line and a connection to the gas return line, said pressure reducer forming a pressure differential of about 15 to 90 pounds per square inch.

51. A system for providing radiant heat, said system comprising:
a main gas line for directing a natural gas stream from a natural gas source to a destination;
a circulation system for circulating a liquid in a closed loop;
a portion of the circulation system passing within close proximity to a line to thereby pass radiant heat from the liquid to the line;
a burner for heating the liquid in the circulation system;
a pump installed into the circulation system, the pump operable to pressurize the liquid in the circulation system;
a compressed-gas powered motor for driving the pump, said compressed-gas powered motor having a motor housing with a gas inlet port and a gas exhaust port;
the compressed-gas powered motor further comprising a gas passageway extending from the gas inlet port to the gas exhaust port inside of the motor housing;
a gas feed line connected to the main gas line and the gas inlet port of the motor housing;
a gas return line connected to the main gas line and the gas exhaust port of the motor housing; and
a pressure reducer disposed in said main gas line between a connection to the gas feed line and a connection to the gas return line.
